(19) United States
(12) Patent Application Publication
(10) Pub. No.: US 2006/0199915 A1
(43) Pub. Date: Sep. 7, 2006

(54) Modified cycloolefin copolymer, process for producing the same, and use of the polymer

(75) Inventors: Jun Izumi, Saitama (JP); Syuji Okamoto, Saitama (JP)

Correspondence Address: THE WEBB LAW FIRM, P.C., 700 KOPPERS BUILDING, 436 SEVENTH AVENUE, PITTSBURGH, PA, 15219, US

(73) Assignee: SOKEN CHEMICAL & ENGINEERING CO., LTD., TOKYO (JP)

(21) Appl. No.: 10/551,831

(22) PCT Filed: Dec. 24, 2003
(86) PCT No.: PCT/JP03/16588

§ 371 Date: Oct. 3, 2005

(30) Foreign Application Priority Data
Apr. 4, 2003 (JP) 2003-102304

(51) Int. Cl. C08F 265/02

(52) U.S. Cl. 525/301

(57) ABSTRACT

A modified cycloolefin copolymer is obtained by chemical modification of a base polymer being a cycloolefin copolymer with ethylene chains, through addition of a modifier compound having a functional group and a hydrogen-donating group or having a functional group and an alkyl halide group, wherein: the functional group is added at a stoichiometric percentage of 20 to 90% of all the replaceable hydrogen atoms in ethylene chains and main-chain cycloolefin chains of the base polymer; and the distribution degree of the functional group-modified cycloolefin copolymer in the base polymer is in the range of 0.01 to 0.1 as expressed in distribution correlation coefficient (DR) defined by the relation (1) below. (DR)=[(RI)−(UV)]² . . . (1) wherein (RI) and (UV) are dispersion indices of molecular weight distributions (=weight-average molecular weight/number-average molecular weight) determined by simultaneous detection based on change of refractive index (RI) and detection based on a UV absorption spectrum characteristic of the functional groups added. Also provided are a process of production and uses of the modified cycloolefin copolypmers.

### FIELD OF THE INVENTION

The present invention relates to modified cycloolefin copolymers. More particularly, the invention relates to modified cycloolefin copolymers that are obtained by chemical modification of cycloolefin copolymers being thermoplastic polymers whose superior properties have historically provided widespread uses including optical materials, display materials, electronic materials and recording materials such as optical disks. The invention also relates to various uses involving the modified cycloolefin copolymers.

The invention further relates to simple industrial processes for producing such modified cycloolefin copolymers.

### BACKGROUND OF THE INVENTION

Cyclic polyolefins, otherwise called cycloolefin copolymers or amorphous polyolefins, are thermoplastic polymeric materials that have recently attracted attention for their superior properties. These polymers have no polar groups depending on the structure, and are therefore low in moisture and water absorption properties. Accordingly, they are highly useful as protective film materials and overcoating materials by taking advantage of water and moisture proofness. Further, the polymers possess excellent optical properties such as high light transmission properties in the visible and ultraviolet regions, high transparency because the polymers do not crystallize and are amorphous in spite of being olefins due to the cyclic structure of the main chains, and remarkably low birefringence because of low polarization. Moreover, their optical properties change little and are stable against environmental changes such as in temperature, as compared with conventional transparent resins such as heat resistant and low-water absorption methacrylic resins having high environmental resistance. The cyclic polyolefins are therefore also called environmental polyolefins. Further, melts thereof have soft flow properties to provide excellent forming properties and dimensional stability of formed products, enabling precision transfer of intricate formed products or molds. Furthermore, the polymers possess high dielectric constants, superior electrical insulating properties and high chemical resistance. These properties including transparency, optical properties, low moisture permeability, forming properties, chemical resistance and heat resistance have enabled various uses as optical members such as lenses and optical fibers, display materials, electronic materials, and recording medium materials such as optical media including CD, MO and DVD.

As such, various proposals have been made for improving or modifying the properties of the cycloolefin copolymers. For example, JP-A-H05-255566 (Patent Document 1) discloses cycloolefin copolymers (COC) grafted with α,β-unsaturated carboxylic acids such as maleic anhydride, styrenes and unsaturated epoxy components to modify the flow properties, mechanical properties and water absorption properties, wherein the cycloolefin copolymers are ones of a polycyclic olefin such as norbornene or tetracyclododecene and an acyclic olefin such as ethylene or propylene. A process for COC production is also disclosed. The acid value, an indicator of graft modification rate with maleic anhydride, is described to be not more than 23 (mgKOH/g).

JP-A-H03-95286 (Patent Document 2) discloses ethylene/cycloolefin random copolymers that are graft modified with α,β-unsaturated carboxylic acids, amides, imides, acid anhydrides and unsaturated epoxy, and adhesives for cycloolefin resins that include the modified cycloolefin random copolymers. The disclosure describes that maleic acid and maleic anhydride are preferable modifiers. The modification is conducted in a manner such that the cycloolefin copolymer is mixed with a solution of the modifier in a solvent, and graft modification is performed using a radical initiator.

JP-A-2000-298350 (Patent Document 3) describes photoresist resin compositions that include a cyclic olefin polymer comprising cyclic olefin units having an acidic polar functional group such as carboxyl group that promote solubility in aqueous alkaline solutions, and cyclic olefin units having an acid-labile group that inhibit solubility in aqueous alkaline solutions.

JP-A-H06-211937 (Patent Document 4) discloses substrates for recording media such as optical disks and compact disks that comprise norbornene/ethylene or tetracyclododecene/ethylene cyclic cycloolefin copolymers.
Patent Document 1: JP-A-H05-255566
Patent Document 2: JP-A-H03-95286
Patent Document 3: JP-A-2000-298350
Patent Document 4: JP-A-H06-211937

### DISCLOSURE OF THE INVENTION

As described in Patent Documents 1 to 4, various proposals have been made for modifying or changing properties of the cycloolefin copolymers (hereinafter sometimes abbreviated to COC) as base polymers. However, it is often difficult to modify the cycloolefin copolymers chemically by addition reaction of functional groups, because of the known fact that the cycloolefin copolymers have steric hindrance attributed to the structural skeleton of cycloolefin chain parts of the main chain. For the polymers having such main chain skeletons, proposed is the addition of functional groups under particular conditions such that the cyclic structure will open to perform addition reaction at the main chains of the cycloolefins. However, it is readily understood that chemical addition modification is extremely difficult under normal conditions.

Specifically, this difficulty is evidenced by the fact that the addition level expressed by the acid value of the functional group carboxylic acid by use of the modifier compound maleic anhydride is not always satisfactory as described in Patent Documents 1 to 4. None of the proposals inclusive of these patent documents has been unable to achieve a satisfactory addition level in the addition modification for modifying or improving the properties.

It is therefore an object of the invention to provide modification of the cycloolefin copolymers having excellent properties as described above, namely to provide modified cycloolefin copolymers (hereinafter sometimes abbreviated to modified COC) that are modified at a higher addition level than achieved heretofore, that are modified chemically under conditions permitting modification and improvements of properties, and that are modified at a higher level and more uniformly than known heretofore.

It is another object of the invention to provide a very simple industrial process for producing modified cycloolefin copolymer resins, which is capable of chemical addition modification of cycloolefin copolymers as base polymers without particular conditions using a modifier compound of far higher availability than in the conventional processes so as to modify uniformly the base polymer through the modifying addition reaction.

It is a further object of the invention to provide versatile resins that include the modified cycloolefin copolymer resins produced by the process and that have widespread uses taking advantages of (1) light (such as UV) transmission properties, (2) high transparency and low moisture permeability (or low moisture absorption properties), (3) high transparency, low moisture permeability and low birefringence, (4) high transparency, low moisture permeability, high dielectric constant, electrical insulating properties and heat resistance, (5) soft flow properties of melts, low moisture permeability, high dielectric constant and electrical insulating properties, and (6) high transparency, light transmission properties, high photoelastic modulus, low moisture permeability, high dielectric constant, electrical insulating properties, heat resistance, chemical resistance, forming properties and dimensional stability.

The present inventors made intensive studies to solve the aforementioned problems. They have found that modified cycloolefin copolymers are obtained at a higher addition modification level than achieved heretofore and with uniformity by subjecting cycloolefin copolymers with ethylene chains as unmodified base polymers to the addition of functional groups using modifier compound maleic anhydride that has a carboxyl functional group and a hydrogen-donating group to increase the addition rate of functional groups, while focusing on the reaction system in terms of an “electron accepting-electron donating” relation to cause the addition reaction to take place also in the base polymer's main chains. The present invention has been completed based on the finding.

A modified cycloolefin copolymer according to the present invention is obtained by chemical modification of a base polymer being a cycloolefin copolymer with an ethylene chain, through addition of a modifier compound having a functional group and a hydrogen-donating group or having a functional group and an alkyl halide group, wherein:

the functional group is added at a stoichiometric percentage of 20 to 90% of all the replaceable hydrogen atoms in ethylene chains and main-chain cycloolefin chains of the base polymer; and

the distribution degree of the functional group-modified cycloolefin copolymer in the base polymer is in the range of 0.01 to 0.1 as expressed in distribution correlation coefficient (DR) defined by the relation (1) below:
(DR)=[(RI)−(UV)]² (1)
wherein (RI) and (UV) are dispersion indexes of molecular weight distributions (=weight-average molecular weight/number-average molecular weight) determined by simultaneous detection based on change of refractive index (RI) and detection based on a UV absorption spectrum characteristic of the functional groups added.

The modified cycloolefin copolymers according to the present invention are produced by a process for producing modified cycloolefin copolymers by chemically modifying abase polymer being a cycloolefin copolymer with an ethylene chain through uniform addition of a modifier compound having a functional group and a hydrogen-donating group or having a functional group and an alkyl halide group, the process comprising:

adding 1 to 30 parts by weight of the modifier compound and 20 to 300 parts by weight of an organic solvent to 100 parts by weight of the base polymer in an inactive atmosphere with stirring to give a solution;

while heating the solution at 70 to 95° C. with stirring, adding dropwise 7 to 50 parts by weight of an organic-solvent solution containing 2 to 5 parts by weight of a hydrogen-abstracting peroxide compound dissolved therein, thereby adding the functional group to an ethylene chain and a main-chain cycloolefin chain of the base polymer to yield a modified cycloolefin copolymer; and

thermally aging the copolymer at 90 to 160° C. with stirring for a predetermined time followed by cooling to room temperature to achieve a polymer concentration of 10 to 80 wt %.

The invention provides the modified cycloolefin copolymers in which the functional groups are added at a high level, and the addition of the functional groups is chemically achieved with uniformity, as described in (a) to (c) below:

(a) The modifier compound having a functional group and a hydrogen-donating group or having a functional group and an alkyl halide group is added to ethylene chains and main-chain cycloolefin chains of the cycloolefin copolymer as unmodified base polymer. The functional groups are added at a higher stoichiometric percentage than achieved heretofore, i.e., 20 to 90% of all the replaceable hydrogen atoms in these chains.

(b) The addition sites (or positions at which the addition takes place) range from the ethylene chains to the main-chain cycloolefin chains of the base polymer. That is, the chemical addition is overall and uniform throughout the base polymer. Furthermore, the addition takes place without opening the main-chain cycloolefin chains, and therefore the modified cycloolefin copolymers are not heterogeneous in terms of structure.

(c) The modified cycloolefin copolymers with functional groups added thereto are highly uniform in distribution of the modified cycloolefin copolymer in the base polymer. This uniform distribution in the base polymer is clearly expressed as uniformity of distribution correlation coefficient (DR) defined in the relation (1) below. The (DR) value is in the range of 0.01 to 0.1.
(DR)=[(RI)−(UV)]² (1)
wherein (RI) and (UV) are dispersion indexes of molecular weight distributions (=weight-average molecular weight/number-average molecular weight) determined by simultaneous detection based on change of refractive index (RI) and detection based on a UV absorption spectrum characteristic of the functional groups added.

The invention further provides a very simple industrial process for producing modified cycloolefin copolymers, which involves an additive having excellent hydrogen-abstracting properties in the addition reaction system to convert the ethylene chains and main-chain cycloolefin chains of the base polymer into radicals without ring-opening of the cycloolefin chains, whereby the addition reaction system possesses an “electron accepting-electron donating” relation, and the modifier compound having a functional group and a hydrogen-donating group or having a functional group and an alkyl halide group is incorporated in the base polymer so that the modified cycloolefin copolymer is uniformly distributed and formed in the base polymer.

Specifically, the process for producing modified cycloolefin copolymers chemically modifies the base polymer being a cycloolefin copolymer with ethylene chains, through uniform addition of the modifier compound having a polymerizable unsaturated group (or nucleophilic reactive group) and a functional group, and the process comprises:

adding 1 to 30 parts by weight of the modifier compound and 20 to 300 parts by weight of an organic solvent to 100 parts by weight of the base polymer in an inactive atmosphere with stirring to give a solution;

while heating the solution at 70 to 95° C. with stirring, adding dropwise 7 to 50 parts by weight of an organic-solvent solution containing 2 to 5 parts by weight of a hydrogen-abstracting peroxide compound dissolved therein, thereby adding the functional group to the ethylene chain and main-chain cycloolefin chain of the base polymer to yield a modified cycloolefin copolymer; and

thermally aging the copolymer at 90 to 110° C. with stirring for a predetermined time to uniformly disperse the modified cycloolefin copolymer followed by cooling to room temperature to achieve a polymer concentration inclusive of the modified cycloolefin polymer of 20 to 80 wt %.

The modified cycloolefin copolymer resins provided in the invention by modifying the base polymer through homogeneous (or uniform) addition reaction are suitably and appropriately employed in widespread uses including:

(1) photoresist base resins taking advantage of light (such as UV) transmission properties;

(2) base resins for bonding cycloolefin copolymers taking advantage of high transparency and low moisture permeability;

(3) low-moisture permeable packaging films and optical member films taking advantage of high transparency, low moisture permeability and low birefringence;

(4) various protective film materials and overcoating materials taking advantage of high transparency, low moisture permeability, high dielectric constant, electrical insulating properties and heat resistance;

(5) IC package encapsulating resins taking advantage of soft flow properties and high bonding properties of melts, low moisture permeability, high dielectric constant and electrical insulating properties; and

(6) recording medium substrate materials, light guide plates and medical device resins taking advantage of high transparency, light transmission properties, high photoelastic modulus, low moisture permeability, high dielectric constant, electrical insulating properties, heat resistance, chemical resistance, forming properties and dimensional stability.

### PREFERRED EMBODIMENTS OF THE INVENTION

Hereinbelow, embodiments of the modified cycloolefin copolymers, simple industrial processes for production of the copolymers, and uses of the modified cycloolefin copolymer resins according to the present invention will be further described.

As described above, the modified cycloolefin copolymer (or modified COC) resins of the present invention are characterized in that a modifier compound having a polymerizable unsaturated group and a functional group is added to a base polymer being a cycloolefin copolymer (COC) with ethylene chains, that the functional groups are added at a higher level than achieved heretofore, and that the copolymers are modified or changed chemically with uniformity.

In the present invention, the addition reaction of the functional groups to the COC base polymer occurs preferentially in the ethylene chains of the base polymer for the reasons described hereinabove. The conventional processes often have difficulties in adding the functional groups to a further level, i.e., to the main-chain cycloolefin chains. In contrast, the modified COC production process according to the invention involves a peroxide compound having excellent hydrogen-abstracting properties in the addition reaction system to convert the main-chain cycloolefin chains into radicals without ring opening. The “electron accepting-electron donating” relation permits the functional groups to be added further to the main chains of cycloolefin, which has been difficult with the conventional processes.

The invention thus provides modified copolymers in which the functional groups are added at a higher level than achieved with the conventional processes, without ring opening of the main-chain cycloolefin chain skeletons. Accordingly, the modified copolymers obtained are completely different from those resulting from ring-opening addition reaction under particular conditions as in the conventional processes. Specifically, the modification at least does not produce any heterogeneous structures attributed to ring-opening addition reaction. Therefore, the modified COC are not changed in structural main skeleton of the base polymer. Furthermore, the modified COC are characterized in that the functional groups are added uniformly in the entire COC molecules, from the ethylene chains to the radical-converting cycloolefin chains of the COC base polymer.

In the invention, the modification of the COC base polymer by addition of the functional groups can achieve a stoichiometric percentage of the functional groups added in the range of 20 to 90% of all the replaceable hydrogen atoms inclusive of the base polymer's ethylene chains and radical-converting cycloolefin chains.

The modified cycloolefin copolymers of the invention possess the aforementioned properties, and the modification by addition of the functional groups in the base polymer can be readily expressed as distribution degree of the modified cycloolefin copolymer in the base polymer, using a distribution correlation coefficient (DR) defined by the relation (1) given below.

Specifically, while modified cycloolefin copolymers obtained by a conventional process as described later in Comparative Examples range in (DR) value from 0.5 to 1.0, the modified cycloolefin copolymers obtained in the invention have a (DR) value in the range of 0.01 to 0.1, which is in good agreement with a feature of the invention that the addition modification is highly uniform.
(DR)=[(RI)−(UV)]² (1)
wherein (RI) and (UV) are dispersion indexes of molecular weight distributions (weight-average molecular weight/number-average molecular weight). (RI) is detected by change of refractive index of the COC base polymer, while (UV) is by a UV absorption spectrum characteristic of the functional groups in the modified cycloolefin copolymer. Therefore, the relation indicates dispersion indexes of molecular weight distributions as determined through simultaneous detection of (RI) and (UV) of the modified COC. In the invention, the higher the uniformity degree, the higher without limit the similarity of wave patterns of dispersion curves based on the two above, with the (DR) value approximating 0 (zero) without limit.

In the invention, the uniformity of addition modification (uniformity of the modified cycloolefin copolymer) may be evaluated as necessary based on the additivity of molecular weights brought about by addition modification with the functional groups. Specifically, the (unmodified) COC and modified COC are measured for weight-average molecular weight (Mw) and number-average molecular weight (Mn) with GPC (gel permeation chromatography), and molecular weight distribution diagrams of COC and modified COC are made. The uniformity degree of addition modification can be evaluated from the measurement values by confirming proportional relation between the increase of molecular weight of the modified COC and the amount in which the modifier compound has been added.

Alternatively, the modified COC obtained using the modifier compound maleic anhydride may be subjected to liquid chromatography to fractionate the modified COC into a high-molecular weight polymer fraction and a low-molecular weight polymer fraction; these fractions are measured for acid value corresponding to what is provided by the addition modification. The amounts of maleic anhydride having undergone the addition reaction are calculated from the acid values, and the uniformity degree of addition modification may be evaluated by deviation of addition molar ratio with respect to the high-molecular weight polymer fraction and the low-molecular weight polymer fraction.

The modifier compounds employable in the invention include compounds having a functional group and a hydrogen-donating group, and compounds having a functional group and an alkyl halide group. The functional groups include carboxyl group, hydroxyl group, amino groups, amide groups, imide groups, alkoxysilyl groups, isocyanate groups, epoxy groups, hydroxyalkyl groups and alkoxyalkyl groups. The invention may appropriately employ modifier compounds having at least one of the functional groups selected from the above depending on the purpose of modification. In the invention, carboxyl group, hydroxyl group, amino groups and epoxy groups are preferably used from the viewpoint of changing the polarity of COC resins. Further, depending on the purpose of modification, the invention may appropriately employ at least one modifier compound selected from compounds having the above functional group and a hydrogen-donating group being a vinyl group or a (meth)acryloyl group, and compounds having the above functional group and an alkyl halide group. The alkyl group in the alkyl halide group may be phenyl or epoxy group as necessary, which is also suitable in the invention.

Examples of the modifier compounds having a functional group and a hydrogen-donating group, and compounds having a functional group and an alkyl halide group include: fluorine-containing vinyl monomers such as perfluoroethylene, perfluoropropylene and vinylidene fluoride; silicon-containing vinyl monomers such as vinyltrimethoxysilane and vinyltriethoxysilane; vinyl esters such as vinyl acetate, vinyl propionate, vinyl n-butyrate, vinyl isobutyrate, vinyl pivalate, vinyl caproate, vinyl versatate, vinyl laurate, vinyl stearate, vinyl benzoate, vinyl p-t-butylbenzoate and vinyl salicylate; vinylidene chloride, vinyl chlorohexanecarboxylate, 2-chloroethyl (meth)acrylate, 2-chloroethyl methacrylate, 3-chloroisopropanol, 4-chloroisobutanol, 2-chloroacetic acid, 3-chloropropionic acid, 3-chloro-2-hydroxypropyl methacrylate, β-methacryloyloxyethylhydrogen phthalate, phenoxyethyl acrylate and 2-hydroxy-3-phenoxypropyl acrylate.

Examples further include unsaturated carboxylic acids such as acrylic acid, methacrylic acid, tetrahydrophthalic acid, itaconic acid, citraconic acid, crotonic acid, isocrotonic acid, norbornenedicarboxylic acid and bicyclo[2,2,1]hept-2-ene-5,6-dicarboxylic acid; derivatives thereof such as maleic anhydride, itaconic anhydride, citraconic anhydride, tetrahydrophthalic anhydride and bicyclo[2,2,1]hept-2-ene-5,6-dicarboxylic anhydride; and amino group-containing monomers with an ethylenically unsaturated bond, including alkyl(meth)acrylate derivatives such as aminoethyl(meth)acrylate, propylaminoethyl(meth)acrylate, dimethylaminoethyl(meth)acrylate, aminopropyl(meth)acrylate, phenylaminoethyl(meth)acrylate and cyclohexylaminoethyl(meth)acrylate; vinylamine derivatives such as N-vinyldiethylamine and N-acetylvinylamine; allylamine derivatives such as allylamine, methacrylamine and N-methylacrylamine; acrylamide derivatives such as N,N-dimethylacrylamide, N,N-dimethylaminopropylacrylamide, acrylamide and N-methylacrylamide; aminostyrenes such as p-aminostyrene; 6-aminohexylsuccinic acid imide and 2-aminoethylsuccinic acid imide.

Examples further include ethylene glycol di(meth)acrylate, triethylene glycol di(meth)acrylate, tetraethylene glycol di(meth)acrylate, diethylene glycol di(meth)acrylate, polypropylene glycol di(meth)acrylate, neopentyl glycol di(meth)acrylate, trimethylolpropane tri(meth)acrylate, pentaerythritol tri(meth)acrylate, 1,1,1-trishydroxymethylethane diacrylate, 1,1,1-trishydroxymethylethane triacrylate, 1,1,1-trishydroxymethylpropane triacrylate and N-methylolacrylamide. Examples further include alkyl acrylates such as methyl(meth)acrylate, ethyl(meth)acrylate, propyl(meth)acrylate, isopropyl(meth)acrylate, butyl(meth)acrylate, isobutyl(meth)acrylate, pentyl(meth)acrylate, hexyl(meth)acrylate, 2-ethylhexyl(meth)acrylate, octyl(meth)acrylate, lauryl(meth)acrylate, nonyl(meth)acrylate, decyl(meth)acrylate, dodecyl(meth)acrylate, phenyl(meth)acrylate, methoxyethyl(meth)acrylate, ethoxyethyl(meth)acrylate, propoxyethyl(meth)acrylate, butoxyethyl(meth)acrylate and ethoxypropyl(meth)acrylate; dialkylaminoalkyl(meth)acrylates such as diethylaminoethyl(meth)acrylate; (meth)acrylamides such as (meth)acrylamide, N-methylol(meth)acrylamide and diacetone acrylamide; epoxy group-containing (meth)acrylates such as glycidyl(meth)acrylate; alicyclic alcohol acrylates such as cyclohexyl(meth)acrylate; and (poly)alkylene glycol di(meth)acrylates such as ethylene glycol di(meth)acrylate, diethylene glycol di(meth)acrylate, triethylene glycol di(meth)acrylate, polyethylene glycol di(meth)acrylate, dipropylene glycol di(meth)acrylate and tripropylene glycol di(meth)acrylate.

Examples further include halogenated styrenes such as fluorostyrene, chlorostyrene, bromostyrene, dibromostyrene and chloromethylstyrene; nitrostyrene, acetylstyrene, methoxystyrene, α-methylstyrene and vinyltoluene.

Examples further include glycidyl methacrylate; monoglycidyl dicarboxylates and diglycidyl dicarboxylates such as monoglycidyl maleate, diglycidyl maleate, monoglycidyl fumarate, diglycidyl fumarate, monoglycidyl crotonate, diglycidyl crotonate, monoglycidyl tetrahydrophthalate, diglycidyl tetrahydrophthalate, monoglycidyl itaconate, diglycidyl itaconate, monoglycidyl butenetricarboxylate, diglycidyl butenetricarboxylate, monoglycidyl citraconate, diglycidyl citraconate, monoglycidyl allylsuccinate and diglycidyl allylsuccinate; alkylglycidyl p-styrenecarboxylates; allylglycidylether, glycidyl ether acrylate, glycidyl ether methacrylate, 2-ethylglycidyl ether acrylate, 2-ethylglycidyl ether methacrylate, 2-methylallyl glycidyl ether, styrene-p-glycidyl ether and glycidyl acrylate.

Hydroxyl group-containing polymerizable compounds are also employable, with examples including 2-hydroxyethyl acrylate, 2-hydroxyethyl methacrylate, 2-hydroxypropyl acrylate, monoesters of acrylic or methacrylic acid with polypropylene glycol or polyethylene glycol, and adducts of 2-hydroxyethyl (meth)acrylate with lactones.

Amide group-containing vinyl monomers are also employable, with examples including methacrylamide, N-methylolmethacrylamide, N-methoxyethylmethacrylamide and N-butoxymethylmethacrylamide. Amino group-containing ethylenically unsaturated compounds are also employable, with examples including alkyl(meth)acrylate derivatives such as aminoethyl(meth)acrylate, propylaminoethyl(meth)acrylate, dimethylaminoethylmethacrylate, aminopropyl(meth)acrylate, phenylaminoethyl methacrylate and cyclohexylaminoethyl methacrylate; vinylamine derivatives such as N-vinyldiethylamine and N-acetylvinylamine; allylamine derivatives such as allylamine, methacrylamine, N-methylacrylamine, N,N-dimethylacrylamide and N,N-dimethylaminopropylacrylamide; acrylamide derivatives such as acrylamide and N-methylacrylamide; aminostyrenes such as p-aminostyrene; (meth)acrylamides such as N-methylol (meth)acrylamide and diacetone acrylamide; 6-aminohexylsuccinic acid imide and 2-aminoethylsuccinic acid imide. Further, amino group-containing monomers with an ethylenically unsaturated bond may also be used appropriately, with examples including alkyl(meth)acrylate derivatives such as aminoethyl(meth)acrylate, propylaminoethyl(meth)acrylate, dimethylaminoethyl methacrylate, aminopropyl(meth)acrylate, phenylaminoethyl methacrylate and cyclohexylaminoethyl methacrylate; vinylamine derivatives such as N-vinyldiethylamine and N-acetylvinylamine; allylamine derivatives such as allylamine, methacrylamine, N-methylacrylamine, N,N-dimethylacrylamide and N,N-dimethylaminopropylacrylamide; acrylamide derivatives such as acrylamide and N-methylacrylamide; aminostyrenes such as N-aminostyrene; 6-aminohexylsuccinic acid imide and 2-aminoethylsuccinic acid imide.

In the present invention, the addition reaction may appropriately involve the modifier compound in an amount of 1 to 40 parts by weight, preferably 3 to 20 parts by weight per 100 parts by weight of the base polymer, depending on the COC base polymer type, the purpose of modification or change, and the type of the functional group and/or hydrogen-donating group or the type of the alkyl halide group of the modifier compound. When the lower limit of the amount is less than 1, the polarity of base polymer resin cannot be improved (or modified) adequately. When the amount exceeds the upper limit 40, an unreacted portion tends to alter properties of the COC base polymer.

COC resins (TOPAS™ manufactured by TICONA JAPAN LTD.) having no polar functional groups were modified by the modified COC production process of the present invention as described later, using the modifier compound maleic anhydride having carboxyl functional groups. The modified cycloolefin copolymers obtained had acid values in the range of 20 to 200 mgKOH/g that corresponded to the amounts of the carboxyl functional groups added in the modified COC resin.

The cycloolefin copolymers (or cyclic olefin polymers) that are precursors (or COC base polymers) of the modified cycloolefin copolymers are not particularly limited, and any precursors may be appropriately used. Examples of the precursor base polymers include cycloolefin copolymers represented by the structural formulae (1) to (13) given in Chem. 1 later and derivative thereof, and they are selected by structural name of the main-chain cycloolefin chains that are repeating structural units of the COC.

Specifically, the structural names of COC base polymers for use in the present invention include:
bicyclo[2,2,1]hept-2-ene of the formula (1) and bicyclo[2,2,1]hept-2-ene derivatives of the formula (1) such as 6-methylbicyclo[2,2,1]hept-2-ene, 5,6-dimethylbicyclo[2,2,1]hept-2-ene, 1-methylbicyclo[2,2,1]hept-2-ene, 6-ethylbicyclo[2,2,1]hept-2-ene, 6-n-butylbicyclo[2,2,1]hept-2-ene, 6-isobutylbicyclo[2,2,1]hept-2-ene and 7-methylbicyclo[2,2,1]hept-2-ene; tetracyclo[4,4,0,1^{2,5},1^{7,10}]-3-dodecene of the formula (2) and tetracyclo[4,4,0,1^{2,5},1^{7,10}]-3-dodecene derivatives of the formula (2) such as 5,10-dimethyltetracyclo[4,4,0,1^{2,5},1^{7,10}]-3-dodecene, 2,10-dimethyltetracyclo[4,4,0,1^{2,5},7^{7,10}]-3-dodecene, 11,12-dimethyltetracyclo[4,4,0,1^{2,5},1^{7,10}]-3-dodecene, 2,7,9-trimethyltetracyclo[4,4,0,1^{2,5},1^{7,10}]-3-dodecene, 9-ethyl-2,7-dimethyltetracyclo[4,4,0,1^{2,5},1^{7,10}]-3-dodecene, 9-isobutyl-2,7-dimethyltetracyclo [4,4,0,1^{2,5},1^{7,10}]-3-dodecene, 9,11,12-trimethyltetracyclo[4,4,0,1^{2,5},1^{7,10}]-3-dodecene, 9-isobutyl-11,12-dimethyltetracyclo [4,4,0,1^{2,5},1^{7,10}]-3-dodecene, 5,8,9,10-tetramethyltetracyclo[4,4,0,1^{2,5},1^{7,10}]-3-dodecene, 8-stearyltetracyclo[4,4,0,1^{2,5},1^{7,10}]-3-dodecene, 8-methyl-9-ethyltetracyclo[4,4,0,1^{2,5},1^{7,10}]-3-dodecene, 8-fluorotetracyclo[4,4,0,1^{2,5},1^{7,10}]-3-dodecene, 8-cyclohexyltetracyclo[4,4,0,1^{2,5},1^{7,10}]-3-dodecene, 8-isobutyltetracyclo[4,4,0,1^{2,5},1^{7,10}]-3-dodecene, 8-ethylidenetetracyclo[4,4,0,1^{2,5},1^{7,10}]-3-dodecene, 8-ethylidene-9-methyltetracyclo[4,4,0,1^{2,5},1^{7,10}]-3-dodecene, 8-ethylidene-9-isopropyltetracyclo [4,4,0,1^{2,5},1^{7,10}]-3-dodecene, 8-n-propylidenetetracyclo[4,4,0,1^{2,5},1^{7,10}]-3-dodecene, 8-n-propylidene-9-isopropyltetracyclo [4,4,0,1^{2,5},1^{7,10}]-3-dodecene, 8-isopropylidenetetracyclo[4,4,0,1^{2,5},1^{7,10}]-3-dodecene and 8-isopropylidene-9-ethyltetracyclo [4,4,0,1^{2,5},1^{7,10}]-3-dodecene; hexacyclo[6,6,1,1^{3,5},1^{10,13},0^{2,7},0^{9,14}]-4-heptadecene of the formula (3) and hexacyclo[6,6,1,1^{3,5},1^{10,13},0^{2,7},0^{9,14}]-4-heptadecene, derivatives of the formula (3) such as 12-methylhexacyclo[6,6,1,1^{3,5},1^{10,13},0^{2,7},0^{9,14}]-4-heptadecene, 12-ethylhexacyclo[6,6,1,1^{3,5},1^{10,13},0^{2,7},0^{9,14}]-4-heptadecene, 12-isobutylhexacyclo [6,6,1,1^{3,5},1^{10,13},0^{2,7},0^{9,14}]-4-heptadecene and 10-trimethyl-12-isobutylhexacyclo [6,6,1,1^{3,5},1^{10,13},0^{2,7},0^{9,14}]-4-heptadecene; octacyclo[8,8,0,1^{2,9},1^{4,7},1^{11,19},1^{13,15},0^{3,9},0^{12,17}]-5-docosene of the formula (4) and octacyclo [8,8,0,1^{2,9},1^{4,7},1^{11,19},1^{13,15},0^{3,9},0^{12,17}]-5-docosene derivatives of the formula (4) such as 15-methyloctacyclo [8,8,0,1^{2,9},1^{4,7},1^{11,19},1^{13,15},0^{3,9},0^{12,17}]-5-docosene and 15-ethyloctacyclo [8,8,0,1^{2,9},1^{4,7},1^{11,19},1^{13,15},0^{3,9},0^{12,17}]-5-docosene; pentacyclo[6,6,1,1^{3,6},0^{2,7},0^{9,14}]-4-hexadecene of the formula (5) and pentacyclo[6,6,1,1^{3,6},0^{2,7},0^{9,14}]-4-hexadecene derivatives of the formula (5) such as 1,3-dimethylpentacyclo[6,6,1,1^{3,6},0^{2,7},0^{9,14}]-4-hexadecene, 1,6-dimethylpentacyclo[6,6,1,1^{3,6},0^{2,7},0^{9,14}]-4-hexadecene and 15,16-dimethylpentacyclo[6,6,1,1^{3,6},0^{2,7},0^{9,14}]-4-hexadecene; heptacyclo[8,7,0,1,1,1,0,0]-5-eicosene of the formula (6) and heptacyclo-5-icosene derivatives of the formula (6); tricyclo[4,3,0,1^{2,5}]-3-decene of the formula (7) and tricyclo[4,3,0,1^{2,5}]-3-decene derivatives of the formula (7) such as 2-methyltricyclo[4,3,0,1^{2,5}]-3-decene and 5-methyltricyclo[4,3,0,1^{2,5}]-3-decene; tricyclo[4,4,0,1^{2,5}]-3-undecene of the formula (8) and tricyclo[4,4,0,1^{2,5}]-3-undecene derivatives of the formula (8) such as 10-methyl-tricyclo[4,4,0,1^{2,5}]-3-undecene; pentacyclo[6,5,1,1^{3,6},0^{2,7},0^{9,13}]-4-pentadecene of the formula (9) and pentacyclo[6,5,1,1^{3,6},0^{2,7},0^{9,13}]-4-pentadecene derivatives of the formula (9) such as 1,3-dimethyl-pentacyclo[6,5,1,1^{3,6},0^{2,7},0^{9,13}]-4-pentadecene, 1,6-dimethyl-pentacyclo[6,5,1,1^{3,6},0^{2,7},0^{9,13}]-4-pentadecene and 14,15-dimethyl-pentacyclo [6,5,1,1^{3,6},0^{2,7},0^{9,13}]-4-pentadecene; diene compounds of the formula (10) such as pentacyclo[6,5,1,1^{3,6},0^{2,7},0^{9,13}]-4,10-pentadecadiene; pentacyclo[4,7,0,1^{2,5},0^{9,13},1^{9,12}]-4-pentadecene of the formula (11) and pentacyclo[4,7,0,1^{2,5},0^{9,13},1^{9,12}]-4-pentadecene derivatives of the formula (11) such as methyl-substituted pentacyclo[4,7,0,1^{2,5},0^{9,13},1^{9,12}]-4-pentadecene; heptacyclo[7,8,0,1^{3,6},0^{2,7},1^{15,17},0^{11,19},1^{12,15}]-4-eicosene of the formula (12) and heptacyclo [7,8,0,1^{3,6},0^{2,7},1^{15,17},0^{11,19},1^{12,15}]-4-eicosene derivatives of the formula (12) such as dimethyl-substituted heptacyclo[7,8,0,1^{3,6},0^{2,7},1^{15,17},0^{11,19},1^{12,15}]-4-eicosene; and nonacyclo [9,10,1,1^{4,7},0^{3,9},0^{2,15},0^{12,21},1^{13,29},0^{14,19},1^{15,18}]-5 pentacosene of the formula (13) and nonacyclo [9,10,1,1^{4,7},0^{3,9},0^{2,15},0^{12,21},1^{13,29},0^{14,19},1^{15,18}]-5-pentacosene derivatives of the formula (13) such as trimethyl-substituted nonacyclo [9,10,1,1^{4,7},0^{3,9},0^{2,15},0^{12,21},1^{13,29},0^{14,19},1^{15,18}]-5-pentacosene.

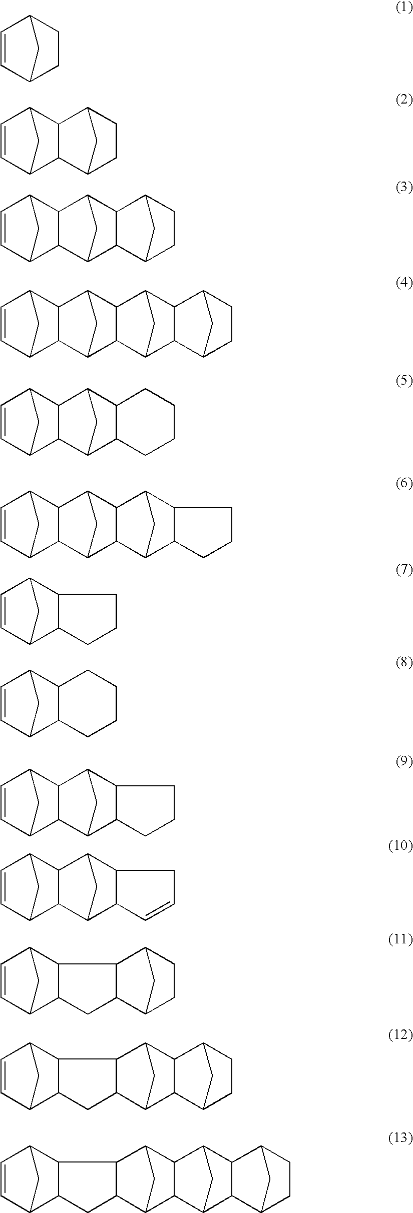

In the present invention, the COC base polymer as precursor is chemically modified and changed in properties to give the modified COC of the invention. For the modification, the invention involves a hydrogen-abstracting peroxide compound in the addition reaction system as specific addition initiator and addition accelerating additive.

Examples of the peroxide compounds include organic peroxides, organic hydroperoxides and organic peroxyketals. The organic peroxides include dicumyl peroxide, di-tert-butyl peroxide, tert-butylcumyl peroxide, dilauroyl peroxide, dibenzoyl peroxide, diacetyl peroxide, didecanoyl peroxide, diisononanoyl peroxide and 2-methylpentanoyl peroxide. The organic hydroperoxides include tert-butyl hydroperoxide, cumyl hydroperoxide, 2,5-dimethyl-2,5-dihydroperoxy hexane, p-methane hydroperoxide and diisopropylbenzene hydroperoxide. The organic peroxyketals include 1,1-bis(tert-hexylperoxy)-3,3,5-trimethylcyclohexane, 1,1-bis(tert-hexylperoxy)cyclohexane and 1,1-bis (tert-butylperoxy) 3,3, 5-trimethylcyclohexane. Further, persulfates such as potassium persulfate and ammonium persulfate, and peroxide compounds such as benzoyl peroxide and lauryl peroxide are also preferably used.

For the purpose of modification or change, the peroxide compounds may be appropriately added in the addition reaction system singly or as composite compounds including at least two types of the peroxide compounds. The peroxide compounds may be appropriately added in amounts such that the ratio thereof to the nucleophilic reactive groups in the modifier compound in terms of number of moles of radicals will be 0.7-2.5/1, preferably 1-2.5/1. When the ratio is below the lower limit 0.7, adequately abstracting hydrogen from the base polymer COC resin tends to be difficult. More preferably, the lower limit is not more than 1. On the other hand, when the ratio is above the upper limit 2.5, the radicals are involved in undesired side reactions other than the hydrogen abstraction.

The modified COC production process of the invention modifies the cycloolefin copolymer (base polymer) having ethylene chains through addition reaction with the modifier compound having a functional group and a hydrogen-donating group or having a functional group and an alkyl halide group, whereby modified cycloolefin copolymers whose properties are modified or changed to a higher level than achieved heretofore can be appropriately obtained. Preferred embodiments of the production processes will be described hereinbelow.

In a preferred embodiment of the modified COC production process of the present invention, the aforesaid peroxide compounds are added in the addition reaction system to modify or change the properties to a higher level than achieved heretofore, as described below.

The precursor base polymer is appropriately selected from the cycloolefin copolymers and derivatives thereof having the structural formulae (1) to (13) given above. In an inactive atmosphere and with stirring, 100 parts by weight of the base polymer is added to 1 to 40 parts by weight of the modifier compound and 20 to 300 parts by weight of an organic solvent, to give a solution. While heating the solution at 70 to 95° C. with stirring, 7 to 50 parts by weight of an organic-solvent solution containing 2 to 5 parts by weight of the hydrogen-abstracting peroxide compound is added dropwise to the solution. In the thus-formed system including the peroxide compound, the functional groups are successively added to the ethylene chains and cycloolefin main chains of the base polymer to yield a modified cycloolefin copolymer. Subsequently, the modified cycloolefin copolymer is thermally aged at least at 90 to 160° C. with stirring for 1 to 10 hours, followed by cooling to room temperature. Thus, a modified cycloolefin copolymer with a polymer concentration of 10 to 80 wt % is produced. As described hereinabove, the polymerization degree of the modified cycloolefin copolymer depends on that of the unmodified COC used as the precursor. In the invention, the modified cycloolefin copolymer may be cleaned with a solvent as required. Further, for the reasons given above, it is extremely important that the peroxide compounds be added to the addition reaction system in amounts such that the ratio thereof to the nucleophilic reactive groups in the modifier compound in terms of number of moles of radicals will be 0.7-2.5/1.

The modified cycloolefin copolymers obtained by the above production processes display various properties that are modified or changed from the inherent properties of the cycloolefin copolymers as unmodified base polymers. For example, the production processes of the invention provide modified cycloolefin copolymer resins suitably used as: (1) photoresist resin compositions taking advantage of light (such as UV) transmission properties and adhesive properties; (2) adhesive resin compositions for cycloolefin copolymer materials taking advantage of high transparency and low moisture permeability; (3) low-moisture permeable (packaging) films and optical member films taking advantage of high transparency, low moisture permeability and low birefringence; (4) various protective films, overcoating materials, optical members and recording medium substrate resins taking advantage of high transparency, low moisture permeability, high dielectric constant, electrical insulating properties and heat resistance; (5) IC package encapsulating resins taking advantage of soft flow properties and high bonding properties of melts, low moisture permeability, high dielectric constant and electrical insulating properties; and (6) recording medium substrate resins, medical device resins and light guide plate resins taking advantage of high transparency, light transmission properties, high photoelastic modulus, low moisture permeability, high dielectric constant, electrical insulating properties, heat resistance, chemical resistance, forming properties and dimensional stability.

In the invention, heretofore known additives may be added for improving practical properties of the modified cycloolefin copolymer resins without deteriorating the properties for the intended use. Examples of the additives include polymerization initiators, polymerization inhibitors, curing accelerators, low shrinkage agents, thickening agents, internal mold lubricants, dispersants, plasticizers, lubricants, film-forming auxiliaries, releasing agents, anti-foaming agents, anti-flaming agents, flame-retardants, antistatic agents, conductivity imparting agents, ultraviolet light absorbers, ultraviolet light sensitizers, fluorescent brighteners, anti-fogging agents, antibacterial and antifungal agents, photocatalysts, organic and inorganic fillers including fibrous fillers, dyes and pigments. These additives may be appropriately used singly or in combination of two or more kinds. The amount of the additives depends on the type thereof and is appropriately selected as required. Specifically, the amount is generally in the range of 0.01 to 100 parts by weight, preferably not more than 50 parts by weight, more preferably not more than 20 parts by weight, per 100 parts by weight of the modified cycloolefin copolymer resin.

Of the above additives, for example, the inorganic and organic fillers of various shapes such as fine powder, scales and fibers (or whiskers) may be appropriately added for improving or increasing the tensile strength or preventing deflection of sheet materials, and for improving sheet surface properties such as AB (anti-blocking) properties. Examples of such fillers include calcium carbonate, magnesium carbonate, barium sulfate, aluminum hydroxide, magnesium hydroxide, alumina powder, red oxide, silica, synthetic smectite, synthetic zeolite, magnesium titanate, synthetic basic lithium carbonate-aluminum salt, synthetic basic lithium carbonate-magnesium salt, synthetic calcium silicate, synthetic magnesium silicate, synthetic mica, wollastonite, nepheline syenite, talc, diatomaceous earth, mica, kaolin, glass powder and various organic polymer fine particles. These may be used singly or in combination of two or more kinds. They are appropriately selected after consideration of their particle sizes and refractive indexes to avoid lowering in transparency of sheets. Further, fibrous reinforcing agents may be used, with examples including glass fibers, carbon fibers, organic fibers and potassium titanate fibers. These fibers range in length from 0.1 to 20 mm, preferably from 1 to 10 mm. In view of compatibility and dispersion properties with the resins of the invention, the fine-powder or fibrous fillers may be previously surface treated with silane-based or titanate-based coupling agents or be used in combination with appropriate dispersants.

### EXAMPLES

Hereinbelow, the present invention will be described by Examples. However, it should be construed that the invention is not limited thereto.

<Molecular Weight>

Weight-average molecular weights (Mw) were determined by GPC (gel permeation chromatography). GPC involved columns GMH-HT and GMH-HTL (manufactured by TOSOH CORPORATION) and orthodichlorobenzene as solvent.

<Measurement of (RI)>

(RI) was determined by measuring the change in refractive index of effluent using a quartz glass cell by means of a Bryce-type double-bath double-roll system, with use of a tungsten lamp as light source.

<Measurement of (UV)>

(UV) was determined by measuring the change in absorbance at a UV absorption wavelength of 254 nm by means of a dual beam single flow-cell system, with use of a deuterium lamp as light source.

<(DR)>

(DR) was determined from the relation (1) by simultaneously detecting the dispersion indexes of molecular weight distributions (weight-average molecular weight/number-average molecular weight) based on change of refractive index (RI) and based on a UV absorption spectrum (UV) characteristic of the functional groups added to the modified COC.

### Example 1

In an inactive atmosphere and with stirring, 10 parts by weight of maleic anhydride and 50 parts by weight of toluene were added to 100 parts by weight of a base polymer being a cycloolefin copolymer with ethylene chains, to give a solution. While the solution was heated at 95° C. and stirred, 50 parts by weight of a toluene solution containing 10 parts by weight of benzoyl peroxide dissolved therein was added dropwise. Subsequently, the mixture was thermally aged at 100° C. with stirring for 3 hours and was cooled to room temperature. Thus, a resin solution with 52 wt % nonvolatile components was obtained. The modified cycloolefin copolymer obtained had (RI) of 3.23 and (UV) of 3.03. The distribution correlation coefficient (DR) was determined to be 0.04.

### Example 2

Likewise in Example 1, in an inactive atmosphere and with stirring, 20 parts by weight of maleic anhydride and 50 parts by weight of toluene were added to 100 parts by weight of a base polymer being a cycloolefin copolymer with ethylene chains, to give a solution. While the solution was heated at 95° C. and stirred, 50 parts by weight of a toluene solution containing 25 parts by weight of benzoyl peroxide dissolved therein was added dropwise. Subsequently, the mixture was thermally aged at 100° C. with stirring for 3 hours and was cooled to room temperature. Thus, a resin solution with 54 wt % nonvolatile components was obtained. The modified cycloolefin copolymer obtained had (RI) of 3.07 and (UV) of 2.87. The distribution correlation coefficient (DR) was determined to be 0.04.

### Example 3

Likewise in Example 1, in an inactive atmosphere and with stirring, 15 parts by weight of 2-methylallyl glycidyl ether as chemical material having nucleophilic reactive groups and 50 parts by weight of toluene were added to 100 parts by weight of a base polymer being a cycloolefin copolymer with ethylene chains, to give a solution. While the solution was heated at 95° C. and stirred, 50 parts by weight of a toluene solution containing 2 parts by weight of benzoyl peroxide dissolved therein was added dropwise. Subsequently, the mixture was thermally aged at 100° C. with stirring for 3 hours and was cooled to room temperature. Thus, a resin solution with 53 wt % nonvolatile components was obtained. The modified cycloolefin copolymer obtained had (RI) of 3.17 and (UV) of 2.95. The distribution correlation coefficient (DR) was determined to be 0.05.

### Example 4

Likewise in Example 1, in an inactive atmosphere and with stirring, 20 parts by weight of 4-chloro-1-butanol as chemical material having nucleophilic reactive groups and 50 parts by weight of toluene were added to 100 parts by weight of a base polymer being a cycloolefin copolymer with ethylene chains, to give a solution. While the solution was heated at 95° C. and stirred, 50 parts by weight of a toluene solution containing 2 parts by weight of benzoyl peroxide dissolved therein was added dropwise. Subsequently, the mixture was thermally aged at 100° C. with stirring for 3 hours and was cooled to room temperature. Thus, a resin solution with 54 wt % nonvolatile components was obtained. The modified cycloolefin copolymer obtained had (RI) of 2.94 and (UV) of 2.74. The distribution correlation coefficient (DR) was determined to be 0.04.

### Comparative Example 1

Likewise in Example 1, in an inactive atmosphere and with stirring, 0.5 part by weight of maleic anhydride and 50 parts by weight of toluene were added to 100 parts by weight of a base polymer being a cycloolefin copolymer with ethylene chains, to give a solution. While the solution was heated at 95° C. and stirred, 50 parts by weight of a toluene solution containing 0.25 part by weight of benzoyl peroxide dissolved therein was added dropwise. Subsequently, the mixture was thermally aged at 100° C. with stirring for 3 hours and was cooled to room temperature. Thus, a resin solution with 50 wt % nonvolatile components was obtained. The modified cycloolefin copolymer obtained had (RI) of 4.25 and (UV) of 3.93. The distribution correlation coefficient (DR) was determined to be 0.1.

### Comparative Example 2

Likewise in Comparative Example 1, in an inactive atmosphere and with stirring, 10 parts by weight of maleic anhydride and 50 parts by weight of toluene were added to 100 parts by weight of a base polymer being a cycloolefin copolymer with ethylene chains, to give a solution. While the solution was heated at 95° C. and stirred, 50 parts by weight of a toluene solution containing 0.25 part by weight of benzoyl peroxide dissolved therein was added dropwise. Subsequently, the mixture was thermally aged at 100° C. with stirring for 3 hours and was cooled to room temperature. Thus, a resin solution with 50 wt % nonvolatile componentswasobtained. The modified cycloolefin copolymer obtained had (RI) of 4.56 and (UV) of 4.11. The distribution correlation coefficient (DR) was determined to be 0.2.

### Comparative Example 3

Likewise in Example 1, in an inactive atmosphere and with stirring, 50 parts by weight of maleic anhydride and 50 parts by weight of toluene were added to 100 parts by weight of a base polymer being a cycloolefin copolymer with ethylene chains, to give a solution. While the solution was heated at 95° C. and stirred, 50 parts by weight of a toluene solution containing 15 parts by weight of benzoyl peroxide dissolved therein was added dropwise. Subsequently, the mixture was thermally aged at 100° C. with stirring for 3 hours and was cooled to room temperature. Thus, a resin solution with 60 wt % nonvolatile components was obtained. The modified cycloolefin copolymer obtained had (RI) of 5.12 and (UV) of 4.68. The distribution correlation coefficient (DR) was determined to be 0.2.

To compare the modified COC obtained in Examples with conventional modified COC obtained in Comparative Examples and unmodified COC, these modified or unmodified cycloolefin copolymers, each 30 g, were added to 70 g each of organic solvents of toluene, PGA (propylene glycol monomethylether acetate) and MEK (methyl ethyl ketone), followed by heating at 50° C. to compare the solubilities. The results are shown in Table 1 below, in which AA, BB and CC mean complete dissolution, partial dissolution and no dissolution, respectively.

The modified COC of the invention showed high solubility in any of the solvents, proving that the addition of functional groups to the base polymer molecules had been accomplished far more uniformly than found in the conventional modified COC, as expressed by the distribution correlation coefficients (DR) in Examples above.

TABLE 1

| | Toluene | PGA | MEK |
|---|---|---|---|
| Ex. 1 | AA | AA | AA |
| Ex. 2 | AA | AA | AA |
| Ex. 3 | AA | AA | BB |
| Ex. 4 | AA | AA | BB |
| Comp. Ex. 1 | AA | CC | CC |
| Comp. Ex. 2 | AA | BB | CC |
| Comp. Ex. 3 | AA | BB | BB |
| Unmodified COC | AA | CC | CC |

### INDUSTRIAL APPLICABILITY

As described above, the invention provides very simple industrial processes for producing modified cycloolefin copolymers, wherein the peroxide compounds having excellent hydrogen-abstracting properties are added to the addition reaction system to enable addition of functional groups to ethylene chains of the base polymer COC and further to main-chain cycloolefin chains, which has been difficult with the conventional processes.

The processes convert the main-chain cycloolefin chains into radicals without ring opening, and the “electron accepting-electron donating” relation is created to enable the heretofore-difficult addition to the cycloolefin main chains to a higher level than achieved by the conventional processes. Because the addition reaction is possible without ring opening of the main-chain cycloolefin chain skeletons, the invention can provide modified cycloolefin copolymers in which the functional groups are added uniformly overall in the COC without producing any heterogeneous structures attributed to the ring-opening as encountered in the conventional processes.

1. A modified cycloolefin copolymer obtained by chemical modification of a base polymer being a cycloolefin copolymer with an ethylene chain, through addition of a modifier compound having a functional group and a hydrogen-donating group or having a functional group and an alkyl halide group, wherein:
the functional group is added at a stoichiometric percentage of 20 to 90% of all the replaceable hydrogen atoms in ethylene chains and main-chain cycloolefin chains of the base polymer; and wherein
a distribution degree of the functional group-modified cycloolefin copolymer in the base polymer is in the range of 0.01 to 0.1 as expressed in distribution correlation coefficient (DR) defined by the relation (1) below:
(DR)=[(RI)−(UV)]² (1)
wherein (RI) and (UV) are dispersion indexes of molecular weight distributions (=weight-average molecular weight/number-average molecular weight) determined by simultaneous detection based on change of refractive index (RI) and detection based on a UV absorption spectrum characteristic of the functional groups added.

2. The modified cycloolefin copolymer according to claim 1, wherein the functional group is at least one group selected from the group consisting of carboxyl group, hydroxyl group, amino groups, amide groups, imide groups, alkoxysilyl groups, isocyanate groups, epoxy groups, hydroxyalkyl groups and alkoxyalkyl groups.

3. The modified cycloolefin copolymer according to claim 2, wherein the functional group is a carboxyl group and the amount of the carboxyl group added in terms of acid value is in the range of 20 to 200 mgKOH/g.

4. A process for producing modified cycloolefin copolymers by chemically modifying a base polymer being a cycloolefin copolymer with an ethylene chain through uniform addition of a modifier compound having a functional group and a hydrogen-donating group or having a functional group and an alkyl halide group, the process comprising:
adding 1 to 30 parts by weight of the modifier compound and 20 to 300 parts by weight of an organic solvent to 100 parts by weight of the base polymer in an inactive atmosphere with stirring to give a solution;
while heating the solution at 70 to 95° C. with stirring, adding dropwise 7 to 50 parts by weight of an organic-solvent solution containing 2 to 5 parts by weight of a hydrogen-abstracting peroxide compound dissolved therein, thereby adding the functional group to an ethylene chain and a main-chain cycloolefin chain of the base polymer to yield a modified cycloolefin copolymer; and
thermally aging the copolymer at 90 to 160° C. with stirring for a predetermined time followed by cooling to room temperature to achieve a polymer concentration of 10 to 80 wt %.

5. The process for producing modified cycloolefin copolymers according to claim 4, wherein the functional group is added at a stoichiometric percentage of 20 to 90% of all the replaceable hydrogen atoms in ethylene chains and main-chain cycloolefin chains of the base polymer.

6. The process for producing modified cycloolefin copolymers according to claim 4, wherein the process achieves a distribution degree of the modified cycloolefin copolymer in the base polymer in the range of 0.01 to 0.1 as expressed in distribution correlation coefficient (DR) defined by the relation (1) below:
(DR)=[(RI)−(UV)]² (1)
wherein (RI) and (UV) are dispersion indices of molecular weight distributions (=weight-average molecular weight/number-average molecular weight) determined by simultaneous detection based on change of refractive index (RI) and detection based on a UV absorption spectrum characteristic of the functional groups added.

7. The process for producing modified cycloolefin copolymers according claim 4, wherein the functional group is at least one group selected from the group consisting of carboxyl group, hydroxyl group, amino groups, imide groups, amide groups, epoxy groups, alkoxyalkyl groups, hydroxyalkyl groups and alkoxysilyl groups.

8. The process for producing modified cycloolefin copolymers according claim 4, wherein the hydrogen-donating group is vinyl group or (meth)acryloyl group.

9. The process for producing modified cycloolefin copolymers according to claim 4, wherein the peroxide compound is at least one selected from the group consisting of benzoyl peroxide, lauryl peroxide, di-t-butylperoxyhexahydroterephthalate and dicumyl peroxide.

10. The process for producing modified cycloolefin copolymers according to claim 4, wherein the peroxide compound is added in an amount such that a ratio of the peroxide compound to a polymerizable unsaturated group in the modifier compound in terms of number of moles of radicals is 0.7-2.5/1.

11. A photoresist resin composition obtained using the modified cycloolefin copolymer of claim 1.

12. An adhesive resin composition obtained using the modified cycloolefin copolymer of claim 1 as a main component.

13. A resin for low-moisture permeable films obtained using the modified cycloolefin copolymer of claim 1.

14. A resin for protective films obtained using the modified cycloolefin copolymer of claim 1.

15. A resin for overcoating materials obtained using the modified cycloolefin copolymer of claim 1.

16. A resin for optical members obtained using the modified cycloolefin copolymer of claim 1.

17. A resin for recording medium substrates obtained using the modified cycloolefin copolymer of claim 1.

18. A resin for IC package encapsulating materials obtained using the modified cycloolefin copolymer claim 1.

19. A resin for light guide plates obtained using the modified cycloolefin copolymer of claim 1.

20. The process for producing modified cycloolefin copolymers according to claim 5, wherein the process achieves a distribution degree of the modified cycloolefin copolymer in the base polymer in the range of 0.01 to 0.1 as expressed in distribution correlation coefficient (DR) defined by the relation (1) below:
(DR)=[(RI)−(UV)]² (1)
wherein (RI) and (UV) are dispersion indices of molecular weight distributions (=weight-average molecular weight/number-average molecular weight) determined by simultaneous detection based on change of refractive index (RI) and detection based on a UV absorption spectrum characteristic of the functional groups added.

21. The process for producing modified cycloolefin copolymers according to claim 5, wherein the functional group is at least one group selected from the group consisting of carboxyl group, hydroxyl group, amino groups, imide groups, amide groups, epoxy groups, alkoxyalkyl groups, hydroxyalkyl groups and alkoxysilyl groups.

22. The process for producing modified cycloolefin copolymers according to claim 6, wherein the functional group is at least one group selected from the group consisting of carboxyl group, hydroxyl group, amino groups, imide groups, amide groups, epoxy groups, alkoxyalkyl groups, hydroxyalkyl groups and alkoxysilyl groups.

23. The process for producing modified cycloolefin copolymers according to claim 5, wherein the hydrogen-donating group is vinyl group or (meth)acryloyl group.

24. The process for producing modified cycloolefin copolymers according to claim 6, wherein the hydrogen-donating group is vinyl group or (meth)acryloyl group.

25. The process for producing modified cycloolefin copolymers according to claim 7, wherein the hydrogen-donating group is vinyl group or (meth)acryloyl group.

26. The process for producing modified cycloolefin copolymers according to claim 5, wherein the peroxide compound is at least one selected from the group consisting of benzoyl peroxide, lauryl peroxide, di-t-butylperoxyhexahydroterephthalate and dicumyl peroxide.

27. The process for producing modified cycloolefin copolymers according to claim 6, wherein the peroxide compound is at least one selected from the group consisting of benzoyl peroxide, lauryl peroxide, di-t-butylperoxyhexahydroterephthalate and dicumyl peroxide.

28. The process for producing modified cycloolefin copolymers according to claim 7, wherein the peroxide compound is at least one selected from the group consisting of benzoyl peroxide, lauryl peroxide, di-t-butylperoxyhexahydroterephthalate and dicumyl peroxide.

29. The process for producing modified cycloolefin copolymers according to claim 8, wherein the peroxide compound is at least one selected from the group consisting of benzoyl peroxide, lauryl peroxide, di-t-butylperoxyhexahydroterephthalate and dicumyl peroxide.

30. The process for producing modified cycloolefin copolymers according to claim 5, wherein the peroxide compound is added in an amount such that a ratio of the peroxide compound to a polymerizable unsaturated group in the modifier compound in terms of number of moles of radicals is 0.7-2.5/1.

31. The process for producing modified cycloolefin copolymers according to claim 6, wherein the peroxide compound is added in an amount such that a ratio of the peroxide compound to a polymerizable unsaturated group in the modifier compound in terms of number of moles of radicals is 0.7-2.5/1.

32. The process for producing modified cycloolefin copolymers according to claim 7, wherein the peroxide compound is added in an amount such that a ratio of the peroxide compound to a polymerizable unsaturated group in the modifier compound in terms of number of moles of radicals is 0.7-2.5/1.

33. The process for producing modified cycloolefin copolymers according to claim 8, wherein the peroxide compound is added in an amount such that a ratio of the peroxide compound to a polymerizable unsaturated group in the modifier compound in terms of number of moles of radicals is 0.7-2.5/1.

34. The process for producing modified cycloolefin copolymers according to claim 9, wherein the peroxide compound is added in an amount such that a ratio of the peroxide compound to a polymerizable unsaturated group in the modifier compound in terms of number of moles of radicals is 0.7-2.5/1.
